(19) United States
(12) Patent Application Publication
(10) Pub. No.: US 2025/0292716 A1
(43) Pub. Date: Sep. 18, 2025

(54) DEMURA COMPENSATING METHODS, SYSTEMS, AND MICRO DISPLAY DEVICE

(71) Applicant: JADE BIRD DISPLAY (SHANGHAI) LIMITED, SHANGHAI (CN)

(72) Inventors: Mingxing LI, Shanghai (CN); Jing JU, Shanghai (CN)

(21) Appl. No.: 19/080,953

(22) Filed: Mar. 17, 2025

(30) Foreign Application Priority Data
Mar. 18, 2024 (WO) PCT/CN2024/082151

(51) Int. Cl. G09G 3/20; G09G 3/32

(52) U.S. Cl. CPC G09G 3/2007; G09G 3/32; G09G 2320/0233; G09G 2320/0673

(57) ABSTRACT

A Demura compensating method and system, and a micro display device are provided according to the present disclosure. The method comprises: acquiring an initial display image displayed by pixels of a micro display panel; determining an actual brightness-gray relationship of each pixel from the initial display image; determining an actual gray-level value offset of each pixel based on the actual brightness-gray relationship of each pixel and a preset brightness-gray relationship; and, performing brightness compensation on each pixel to form improved display image data based on the actual gray-level value offset of each pixel. Since the gray level offset is determined for each pixel, compensating accurate and evenness of the display image are improved.

### CROSS-REFERENCE TO RELATED APPLICATIONS

This application claims the benefits of priority to International Application No. PCT/CN2024/082151, filed Mar. 18, 2024, the entire contents of which are incorporated herein by reference.

### FIELD OF THE DISCLOSURE

The present disclosure generally relates to display technology, more particularly, to a Demura compensating method, a Demura compensating system and a related micro display system.

### BACKGROUND OF THE DISCLOSURE

Currently, a micro light emitting diode (LED) display panel has advantages of smaller size, higher refreshing rate, and higher brightness. However, the micro LED display panel suffers from bright unevenness due to production process or long operation time or the like, resulting in residual image, which would reduce the quality level of the micro LED display panel. Therefore, it is necessary to compensate the brightness unevenness of the display panel.

To solve the unevenness phenomenon, the Demura technique of eliminating unevenness has emerged at the right moment. The Demura technology belongs to a kind of external compensation technology, and currently this technology is mainly to illuminate a backplane of a display panel, through a Charge-coupled device (CCD) optical camera, to extract a luminance signal, and detect unevenness of a display image. Based on a central area of the panel, by comparing the difference between a luminance of the central area and the other areas of the display panel, and then calculating a display data to be compensated according to a standard Gamma 2.2 curve, a luminance of the whole display panel is uniform.

The premise of calculating the compensation data is that the display panel has already had a standard Gamma 2.2 curve. However, it is impossible to achieve precise control of the Gamma curve of each piece during an actual production process of the display panel, which causes an uneven gray scale compensation value to be inaccurate and easily affects the final effect of Demura.

The above content is only used to assist in understanding the technical solutions of the present application, and does not constitute an admission that the above is prior art.

### SUMMARY OF THE DISCLOSURE

In order to overcome the drawback mentioned above, the present disclosure provides a Demura compensating method, a Demura compensating system, and a related micro display system, to solve the problem that the uneven compensation value is not accurate, resulting in poor final effect of elimination of unevenness.

To achieve the above objective, the present disclosure provides a Demura compensating method for a micro display panel. The method comprises the following steps: Step 01: acquiring an initial display image displayed by pixels of the micro display panel; Step 02: determining an actual brightness-gray relationship of each pixel from the initial display image; Step 03: determining an actual gray-level value offset of each pixel based on the actual brightness-gray relationship of each pixel and a preset brightness-gray relationship; Step 04: performing brightness compensation on each pixel to form improved display image data based on the actual gray-level value offset of each pixel.

In an embodiment, the step 02 further comprises: acquiring an initial gray-level image from the initial display image; and determining an actual gray coefficient of each pixel based on the relationship of an actual gray-level value and an actual brightness value of each pixel. The relationship of the actual gray-level value and the actual brightness value of a pixel is that: L1=K1×G1, wherein, L1 is an actual brightness value of the pixel, G1 is an actual gray-level value of the pixel, K1 is an actual gray coefficient of the pixel, and Klis a positive integer.

In an embodiment, the step 03 further comprises: determining the actual gray-level value offset of each pixel based on a gray level compensation formula and the actual gray coefficient of each pixel. The gray level compensation formula is: ΔG=(K2-K1)×G1, wherein, AG is the actual gray-level value offset of a pixel, K2 is a standard gray coefficient determined based on the preset brightness-gray relationship. The preset brightness-gray relationship is: L2=K2×G2, wherein, L2 is a standard brightness value of one pixel, G2 is a standard gray-level value of one pixel, K2 is a standard gray coefficient, and K2 is a positive integer.

In an embodiment, the step 04 further comprises: adjusting the gray-level value according to the actual gray-level value offset of each pixel, wherein the bit depth of each pixel is 2 bits, 4 bits, or 8 bits.

In an embodiment, the micro display panel is a micro LED display panel comprising inorganic micro LEDs.

In an embodiment, the standard gray coefficient is larger than the actual gray coefficient of a pixel.

In order to achieve above objective, the present disclosure further provides a Demura compensating system for a micro display panel, comprising: an image acquisition module, configured to perform an image acquisition on the micro display panel to obtain an initial display image displayed by pixels of a micro display panel; a calculation module, configured to determine an actual brightness-gray relationship of each pixel from the initial display image; a central processing module, configured to determine an actual gray-level value offset of each pixel based on the actual brightness-gray relationship of each pixel and a preset brightness-gray relationship; an adjustment module, configured to performing brightness compensation on each pixel to form improved display image data based on the actual gray-level value offset of each pixel.

In an embodiment, the calculation module firstly acquires the initial display image from the image acquisition module. Then, the calculation module transforms the initial display image into an initial gray-level image. Next, the calculation module determines an actual gray coefficient of each pixel based on a relationship of an actual gray-level value and an actual brightness value of each pixel according to the initial gray-level image. The relationship of the actual gray-level value and the actual brightness value of a pixel is that: L1=K1×G1, wherein, L1 is an actual brightness value of the pixel, G1 is an actual gray-level value of the pixel, K1 is an actual gray coefficient of the pixel, and Klis a positive integer.

In an embodiment, the central processing module determines the actual gray-level value offset of each pixel based on a gray level compensation formula and the actual gray coefficient of each pixel; wherein, the gray level compensation formula is: ΔG=(K2−K1)×G1. AG is the actual gray-level value offset of a pixel, K2 is a standard gray coefficient determined based on the preset brightness-gray relationship. The preset brightness-gray relationship is: L2=K2×G2, wherein, L2 is a standard brightness value of one pixel, G2 is a standard gray-level value of one pixel, K2 is the standard gray coefficient, and K2 is a positive integer.

In an embodiment, the Demura compensating system further comprises a flash memory module. The calculation module transmits the actual gray coefficient of each pixel to the flash memory module. Then, the central processing module acquires the actual gray coefficient of each pixel from the flash memory module.

In an embodiment, the Demura compensating system further comprises a system random-access memory (RAM) electrically connected with the flash memory module and the central processing module. The calculation module transmits the actual gray coefficient of each pixel to the flash memory module. Then, the flash memory module transmits the actual gray coefficient of each pixel to the system RAM. Finally, the central processing module acquires the actual gray coefficient of each pixel from the system RAM.

In an embodiment, the adjustment module acquires the actual gray-level value offset of each pixel from the central processing module, performs brightness compensation on each pixel to form the improved display image data based on the actual gray-level value offset of each pixel, and transmits the improved display image data to the micro display panel.

In an embodiment, the Demura compensating system further comprises: a static random-access memory (SRAM), electrically connected with the adjustment module and the micro display panel. The adjustment module performs brightness compensation on each pixel and sent improved brightness data of each pixel to the SRAM. When all of the improved brightness data of all of the pixels are sent to the SRAM to form whole improved image data, the SRAM sends the whole improved image data to the micro display panel.

In an embodiment, the adjustment module further adjusts the gray-level value for each pixel according to the actual gray-level value offset of each pixel, wherein the bit depth of each pixel is 2 bits, 4 bits, or 8 bits.

In an embodiment, the micro display panel is a micro LED display panel comprising inorganic micro LEDs.

In an embodiment, the standard gray coefficient is larger than the actual gray coefficient of a pixel.

In order to achieve above objective, the present disclosure further provides a micro display device for a micro display panel, comprising the Demura compensating system mentioned above.

In an embodiment, the micro display device further comprises: a circuit board, having a first end and a second end; a micro display panel, formed on a surface of the first end of the circuit board and electrically connected with the circuit board; a support base, formed on the other surface of the first end of the circuit board opposite to the micro display panel; a flash memory, having the flash memory module mentioned above and formed on a surface of the second end of the circuit board and electrically connected with the circuit board; and a central processing unit, formed on the other surface of the second end of the circuit board opposite to the flash memory and electrically connected with the flash memory and the circuit board. The central processing unit has the central processing module and the adjustment module mentioned above.

In an embodiment, the adjustment module further adjusts the gray-level value for each pixel based on the actual gray-level value offset of each pixel, wherein the bit depth of each pixel is 2 bits, 4 bits, or 8 bits.

In an embodiment, the micro display panel is a micro LED display panel comprising inorganic micro LEDs.

In an embodiment, the standard gray coefficient is larger than the actual gray coefficient of a pixel.

The Demura compensating method for a micro display panel proposed in the present disclosure can compensate the brightness value of every pixel based on the actual gray-level value offset of each pixel, furthermore, based on the actual gray coefficient of each pixel and the standard gray coefficient, which is called as a compensating coefficient for uneven brightness in the micro display panel, thereby improving the compensation accurate and the final effect of elimination of unevenness.

### BRIEF DESCRIPTION OF THE DRAWINGS

FIG. 1 is a flow chart illustrating a Demura compensating method for a micro display panel according to an embodiment of the present disclosure;

FIG. 2 is a schematic block diagram of a Demura compensating system for a micro display panel according to an embodiment of the present disclosure;

FIG. 3 is a structural diagram of a micro display device according to an embodiment of the present disclosure;

FIG. 4 is a structural diagram of a pin list on the IC panel according to an embodiment of the present disclosure;

FIG. 5 is a schematic block diagram of a Demura compensating system according to an embodiment of the present disclosure; and

FIG. 6 is a schematic block diagram of a Demura compensating system according to another embodiment of the present disclosure.

### DETAILED DESCRIPTION OF THE EMBODIMENTS

Reference will now be made in detail to the present preferred embodiments to provide a further understanding of the disclosure. The specific embodiments and the accompanying drawings discussed are merely illustrative of specific ways to make and use the disclosure, and do not limit the scope of the disclosure or the appended claims.

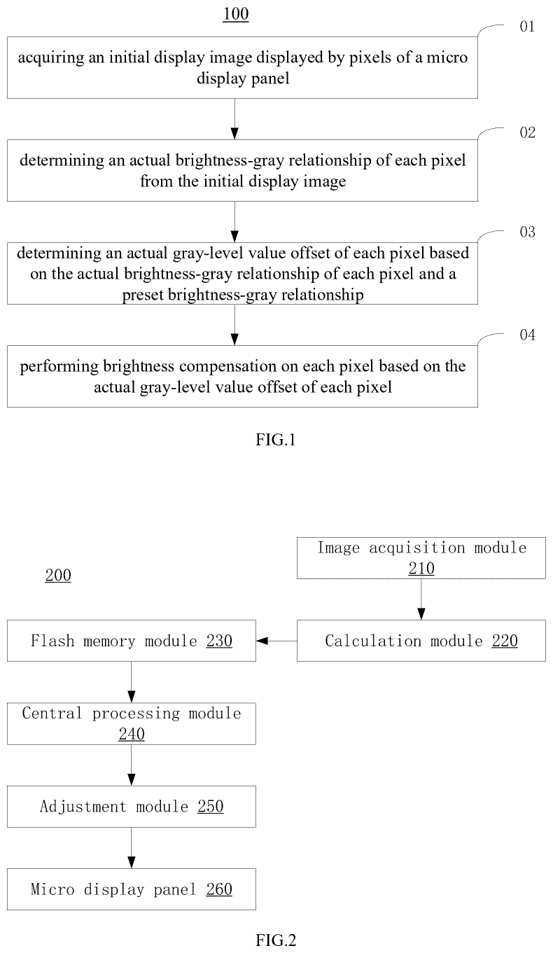

To resolve the problem in the related technologies, a Demura compensating method is provided in embodiments of the present disclosure. FIG. 1 is a flow chart illustrating a Demura compensating method 100 for a micro display panel according to an embodiment of the present disclosure. Referring to FIG. 1, the Demura compensating method 100 for a micro display panel comprises the following steps 01 to 04.

Step 01: acquiring an initial display image displayed by pixels of the micro LED display panel.

In step 01, the initial display image can be acquired by using a charge-coupled device (CCD).

The micro display panel can be a micro LED display panel. The micro LED display panel comprises a micro LED array that forms a pixel array, such as a 640×480 pixel array. The micro LED display panel also comprises: an IC back plane, and a micro LED display plane electrically connected and bonded with the IC back plane. The micro LED display plane comprises the micro LED array, which comprises a plurality of inorganic micro LEDs to show display images. Micro LED can comprise inorganic LED or organic LED. On the IC back plane, an electrode connected area is electrically connected with the micro LED array and a signal line area is formed around the electrode connected area. The IC back plane acquires signals such as image data from outside via signal lines to control a corresponding micro LED to emit light. The IC back plane generally employs an 8-bit Digital to analog converter (DAC). The 8-bit DAC has 256 levels of manifestations, and each level corresponds to one gray level, that is, the 8-bit DAC may provide 256 different gray levels. Since any one of the 256 gray levels may be applied on the micro LED, a gray level ranging from 0 to 255 may be displayed by one pixel. Optionally, a brightness value of the micro LED can be controlled by voltage amplitudes or current amplitudes of the signals acquired by the IC back plane, while the gray levels can be shown by time intervals, e.g., pulse widths, of the signals.

It is understood by those skilled in the art that, the micro display panel is not limited by the structure mentioned above, and may include more or less components than those as illustrated, or some components may be combined, or a different component may be utilized.

Step 02: determining an actual brightness-gray relationship of each pixel from the initial display image.

In step 02, an actual brightness-gray relationship of each pixel is determined according to a brightness value and an initial gray-level value of each pixel in the initial display image. Since the brightness value and the gray-level value of each pixel show a liner relationship in the micro display panel, the actual brightness-gray relationship of each pixel is also liner.

Optionally, the step 02 further comprises steps 201 and 202 (not shown in FIG. 1).

Step 201, acquiring an initial gray-level image from the initial display image.

In the step 201, a computer device converts luminance information of each pixel in the initial display image into gray-level information to obtain the initial gray-level value of the initial display image. It is noted that a computer storage medium is configured in the computer device in the embodiments of the present disclosure. When an image convertor program stored in the storage medium is executed by a processor, a process of forming the initial gray-level image from the initial display image is performed.

Step 202, determining an actual gray coefficient of each pixel based on a relationship of an actual gray-level value and an actual brightness value of each pixel.

In the step 202, the relationship of the actual gray-level value and the actual brightness value of a pixel is that: L1=K1×G1, wherein, L1 is an actual brightness value of the pixel, G1 is an actual gray-level value of the pixel, K1 is an actual gray coefficient of the pixel, and K1 is a positive integer. It is noted that, the actual brightness value and the actual gray-level value can be acquired by an image detector e.g. CCD camera.

Continuing referring to FIG. 1, step 03 comprises: determining an actual gray-level value offset of each pixel based on the actual brightness-gray relationship of each pixel and a preset brightness-gray relationship.

In the step 03, the actual gray-level value offset of each pixel represents a gray-level value by which a pixel is to be compensated. The preset brightness-gray relationship is: L2=K2×G2, wherein, L2 is a standard brightness value of one pixel, G2 is a standard gray-level value of one pixel, K2 is a standard gray coefficient, and K2 is a positive integer. The preset brightness-gray relationship is the same for all of the pixels in the whole display panel.

Herein, the actual gray-level value offset of each pixel is determined based on a gray level compensation formula and the actual gray coefficient of each pixel. The gray level compensation formula is: ΔG=(K2−K1)×G1, wherein, AG is the actual gray-level value offset of a pixel, K1 is the actual gray coefficient of the pixel determined based on the actual brightness-gray relationship, and K2 is the standard gray coefficient determined based on the preset brightness-gray relationship. The actual gray-level value offset AG can be any of zero, positive or negative number. Optionally, the standard gray coefficient K2 is larger than the actual gray coefficient K1 of a pixel. In some embodiments, the standard gray coefficient K2 is not less than the actual gray coefficient K1, so the value of (K2−K1) can be negative. In some embodiments, the standard gray coefficient K2 is equal to the actual gray coefficient K1, that is to say, the actual gray-level value offset is zero.

Step 04: performing brightness compensation on each pixel to form improved display image data based on the actual gray-level value offset of each pixel.

In the step 04, performing brightness compensation on each pixel comprises: adjusting the gray-level value for each pixel according to the actual gray-level value offset. It is noted that, the bit depth value of the pixel can be 2 bits, 4 bits, or 8 bits.

According to the Demura compensating method provided by the embodiments of the present disclosure, the actual gray-level value offset of each pixel is determined based on the actual brightness-gray relationship and a preset brightness-gray relationship; thus, when the initial gray-level value of a pixel varies, the gray-level value offset corresponding to the pixel may vary as well, and the flexibility of the pixel gray-level compensation is improved in comparison with the related technologies. Furthermore, since the brightness-gray relationship is liner, the flexibility and convenience and accurate of the pixel gray-level compensation is further improved.

Additionally, FIG. 2 illustrates a Demura compensating system 200 for a micro display panel 260, according to an embodiment of the present disclosure.

The Demura compensating system 200 for the micro display panel 260 comprises: an image acquisition module 210, configured to perform an image acquisition on the micro display panel 260 to obtain an initial display image displayed by the pixels of the micro display panel 260; a calculation module 220, configured to determining an actual brightness-gray relationship of each pixel from the initial display image; a central processing module 240, configured to determining an actual gray-level value offset of each pixel based on the actual brightness-gray relationship and a preset brightness-gray relationship; and an adjustment module 250, configured to performing brightness compensation on each pixel to form improved display image data based on the actual gray-level value offset of each pixel. Optionally, the Demura compensating system 200 further comprises a flash memory module 230, configured to store the actual gray coefficient, the actual gray-level value offset, the standard gray coefficient, etc.

Optionally, the calculation module 220 firstly acquires the initial display image from the image acquisition module. Then, the calculation module 220 transforms the initial display image into an initial gray-level image to obtain an actual gray-level value of each pixel. Next, the calculation module 220 determines an actual gray coefficient based on a relationship of the actual gray-level value and an actual brightness value of each pixel according to the initial gray-level image. The relationship of the actual gray-level value and the actual brightness value of a pixel is that: L1=K1×G1, wherein, L1 is an actual brightness value of the pixel, G1 is an actual gray-level value of the pixel, K1 is an actual gray coefficient of the pixel, and Klis a positive integer. Additionally, the calculation module 220 transmits the actual gray coefficient of each pixel to the flash memory module 230.

Then, the central processing module 240 acquires the actual gray coefficient of each pixel from the flash memory module 230 and determines the actual gray-level value offset of each pixel based on a gray level compensation formula and the actual gray coefficient of each pixel. The gray level compensation formula is: ΔG=(K2−K1)×G1, wherein, AG is the actual gray-level value offset of a pixel, and K2 is a standard gray coefficient determined based on the preset brightness-gray relationship. The preset brightness-gray relationship is: L2=K2×G2, wherein, L2 is a standard brightness value of one pixel, G2 is a standard gray-level value of one pixel, K2 is the standard gray coefficient, and K2 is a positive integer.

Referring to FIG. 5, in some embodiments, the Demura compensating system 200 may further comprise a system random-access memory (RAM) 270. The system RAM 270 is electrically connected with the flash memory module 230 and the central processing module 240. When the calculation module 220 transmits the actual gray coefficient of each pixel to the flash memory module 230, the actual gray coefficient of each pixel is firstly transmitted to the system RAMs 270 and then to the central processing module 240. Alternatively, the central processing module 240 acquires the actual gray coefficient of each pixel from the system RAM 270.

Referring back to FIG. 2, the adjustment module 250 acquires the actual gray-level value offset of each pixel from the central processing module 240, and performs brightness compensation on each pixel to form the improved display image data based on the actual gray-level value offset of each pixel. Then, the adjustment module 250 transmits the improved display image data to the micro display panel 260.

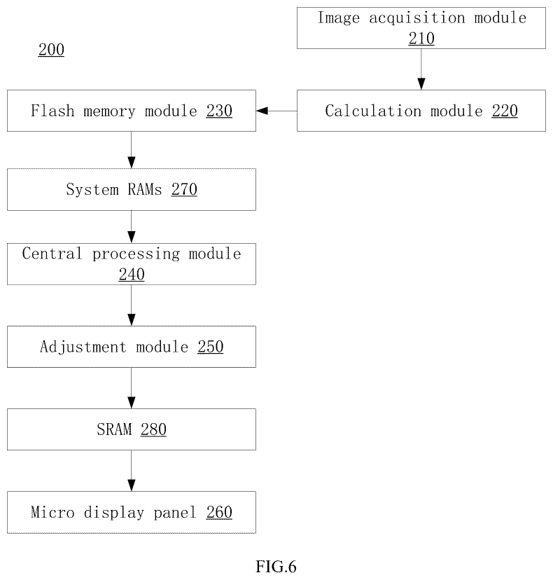

Optionally, referring to FIG. 6, the Demura compensating system 200 further comprises a static random-access memory (SRAM) 280 which is electrically connected with the adjustment module 250 and the micro display panel 260. Additionally, the adjustment module 250 performs brightness compensation on each pixel and sent the improved brightness data of each pixel to the SRAM 280 one by one; when all of the improved brightness data are sent to the SRAM 280 to form a whole improved image data, the SRAM 280 sent the whole improved image data to the micro display panel 260. It is noted that, the bit depth of the initial display image can be 2 bits, 4 bits, or 8 bits.

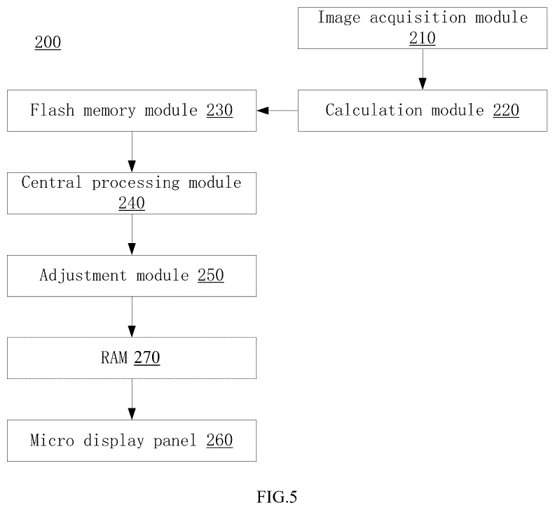

Referring to FIG. 4, illustrating a pin list on an IC panel according to an embodiment of the present disclosure, the connection pins in a signal line area comprises: CS Flash connected the micro LED display plane with the flash memory, VCC, GND, RESTN, SCLK, DIO, PGMDB, VCC, VCOM, etc.

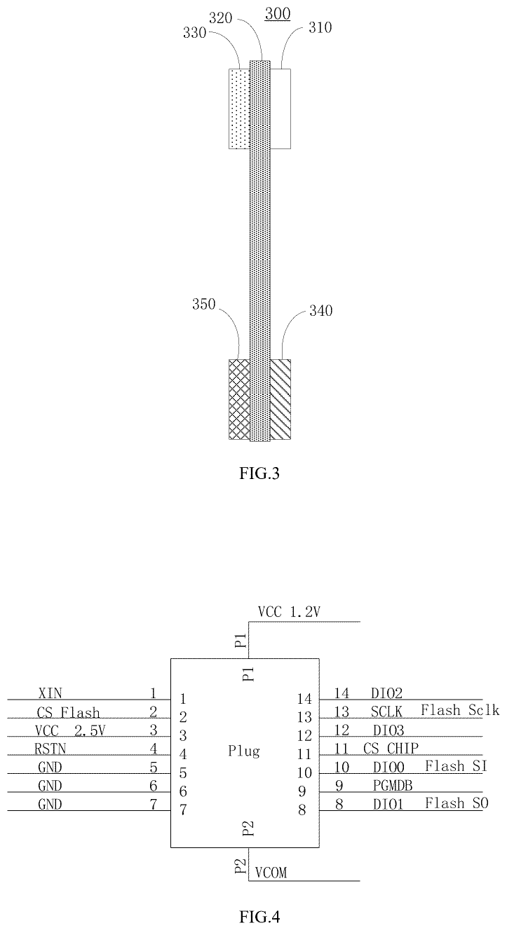

Referring to FIG. 3, illustrating a cross-sectional view of a micro display device 300 for a micro display panel, the micro display panel comprises the Demura compensating system mentioned above. Additionally, the micro display device 300 in the embodiment of the present disclosure further comprises: a circuit board 320, a micro display panel 310, a support base 330, a flash memory 340, and a central processing unit 350. As shown in FIG. 3, the circuit board 320 is long and soft, such as FPC. The long circuit board 320 has a first end and a second end. The micro display panel 310 is formed on a surface of the first end of the circuit board 320 and electrically connected with the circuit board 320. The support base 330 is formed on the other surface of the first end of the circuit board 320 opposite to the micro display panel 310. The flash memory 340 is formed on a surface of the second end of the circuit board 320. Optionally, the flash memory 340 and the micro display panel 310 are formed on the same side of the circuit board 320. It is noted that, the flash memory module 230 mentioned above is configured in the flash memory 340 and electrically connected with the circuit board 320. The central processing unit 350 is formed on the other surface of the second end of the circuit board 320 opposite to the flash memory 340 and electrically connected with the circuit board 320 and the flash memory 340. Additionally, the central processing unit 350 and the support base 330 are configured on the same side of the circuit board 320. It is noted that, the central processing module 240 and the adjustment module 250 mentioned above are configured in the central processing unit 350.

It is understood by those skilled in the art that, all or part of the steps for implementing the foregoing embodiments may be implemented by hardware, or may be implemented by a program which instructs related hardware. The program may be stored in the aforementioned flash memory, in the aforementioned conventional computer device, in the aforementioned central processing module, in the aforementioned adjustment module, etc.

The above descriptions are merely embodiments of the present disclosure, and the present disclosure is not limited thereto. Modifications, equivalent substitutions and improvements made without departing from the conception and principle of the present disclosure shall fall within the protection scope of the present disclosure.

1. A Demura compensating method for a micro display panel, comprising the following steps:
Step 01: acquiring an initial display image displayed by pixels of the micro display panel;
Step 02: determining an actual brightness-gray relationship of each pixel from the initial display image;
Step 03: determining an actual gray-level value offset of each pixel based on the actual brightness-gray relationship of each pixel and a preset brightness-gray relationship; and
Step 04: performing brightness compensation on each pixel to form improved display image data based on the actual gray-level value offset of each pixel.

2. The Demura compensating method for a micro display panel according to claim 1, wherein the step 02 further comprises:
acquiring an initial gray-level image from the initial display image; and
determining an actual gray coefficient of each pixel based on a relationship of an actual gray-level value and an actual brightness value of each pixel,
wherein, the relationship of the actual gray-level value and the actual brightness value of a pixel is that: L1=K1×G1, wherein L1 is an actual brightness value of the pixel, G1 is an actual gray-level value of the pixel, K1 is an actual gray coefficient of the pixel, and K1 is a positive integer.

3. The Demura compensating method for a micro display panel according to claim 2, wherein the step 03 further comprises:
determining the actual gray-level value offset of each pixel based on a gray level compensation formula and the actual gray coefficient of each pixel,
wherein, the gray level compensation formula is: ΔG=(K2−K1)×G1, wherein AG is the actual gray-level value offset of a pixel, K2 is a standard gray coefficient determined based on the preset brightness-gray relationship, and K2 is a positive integer, and
wherein the preset brightness-gray relationship is: L2=K2×G2, wherein, L2 is a standard brightness value of one pixel, and G2 is a standard gray-level value of one pixel.

4. The Demura compensating method for a micro display panel according to claim 1, wherein the step 04 further comprises: adjusting the gray-level value for each pixel according to the actual gray-level value offset of each pixel, wherein a bit depth of each pixel is 2 bits, 4 bits, or 8 bits.

5. The Demura compensating method for a micro display panel according to claim 1, wherein the micro display panel is a micro LED display panel that comprises inorganic micro LEDs.

6. The Demura compensating method according to claim 3, wherein the standard gray coefficient is larger than the actual gray coefficient of a pixel.

7. A Demura compensating system for a micro display panel for a micro display panel, comprising:
an image acquisition module, configured to perform an image acquisition on the micro display panel to obtain an initial display image displayed by pixels of the micro display panel;
a calculation module, configured to determine an actual brightness-gray relationship of each pixel from the initial display image;
a central processing module, configured to determine an actual gray-level value offset of each pixel based on the actual brightness-gray relationship of each pixel and a preset brightness-gray relationship; and
an adjustment module, configured to perform brightness compensation on each pixel to form improved display image data based on the actual gray-level value offset of each pixel.

8. The Demura compensating system for a micro display panel according to claim 7, wherein, the calculation module is configured to:
acquire the initial display image from the image acquisition module;
transform the initial display image into an initial gray-level image; and
determine an actual gray coefficient of each pixel based on a relationship of an actual gray-level value and an actual brightness value of each pixel according to the initial gray-level image,
wherein, the relationship of the actual gray-level value and the actual brightness value of a pixel is that: L1=K1×G1, wherein, L1 is an actual brightness value of the pixel, G1 is an actual gray-level value of the pixel, K1 is the actual gray coefficient, and K1 is a positive integer.

9. The Demura compensating system for a micro display panel according to claim 8, wherein, the central processing module is configured to determine the actual gray-level value offset of each pixel based on a gray level compensation formula and the actual gray coefficient of each pixel,
wherein, the gray level compensation formula is: ΔG=(K2−K1)×G1, wherein, AG is the actual gray-level value offset of a pixel, K2 is a standard gray coefficient determined based on the preset brightness-gray relationship, and K2 is a positive integer, and
wherein, the preset brightness-gray relationship is: L2=K2×G2, wherein, L2 is a standard brightness value of one pixel, and G2 is a standard gray-level value of one pixel.

10. The Demura compensating system for a micro display panel according to claim 9, further comprising a flash memory module,
wherein the calculation module is configured to transmit the actual gray coefficient of each pixel to the flash memory module, and the central processing module is configured to acquire the actual gray coefficient of each pixel from the flash memory module.

11. The Demura compensating system for a micro display panel according to claim 10, further comprising a system random-access memory (RAM) electrically connected with the flash memory module and the central processing module,
wherein the calculation module is configured to transmit the actual gray coefficient of each pixel to the flash memory module, the flash memory module is configured to transmit the actual gray coefficient of each pixel to the system RAM, and the central processing module is configured to acquire the actual gray coefficient of each pixel from the system RAM.

12. The Demura compensating system for a micro display panel according to claim 7, wherein the adjustment module is configured to:
acquire the actual gray-level value offset of each pixel from the central processing module;
perform brightness compensation on each pixel to form the improved display image data based on the actual gray-level value offset of each pixel; and
transmit the improved display image data to the micro display panel.

13. The Demura compensating system for a micro display panel according to claim 12, further comprising a static random-access memory (SRAM), electrically connected with the adjustment module and the micro display panel,
wherein the adjustment module is configured to perform brightness compensation on each pixel and send improved brightness data of each pixel to the SRAM,
when all of the improved brightness data of all of the pixels are sent to the SRAM to form whole improved image data, the SRAM is configured to send the whole improved image data to the micro display panel.

14. The Demura compensating system for a micro display panel according to claim 7, wherein, the adjustment module is configured to adjust the gray-level value for each pixel according to the actual gray-level value offset of each pixel, wherein a bit depth of each pixel is 2 bits, 4 bits, or 8 bits.

15. The Demura compensating system for a micro display panel according to claim 7, wherein, the micro display panel is a micro LED display panel comprising inorganic micro LEDs.

16. The Demura compensating system for a micro display panel according to claim 9, wherein, the standard gray coefficient is larger than the actual gray coefficient of a pixel.

17. A micro display device for a micro display panel, comprising:
the Demura compensating system of claim 7.

18. The micro display device for a micro display panel according to claim 17, wherein, the micro display device further comprising:
a circuit board, having a first end and a second end;
a micro display panel, formed on a surface of the first end of the circuit board and electrically connected with the circuit board;
a support base, formed on the other surface of the first end of the circuit board opposite to the micro display panel;
a flash memory, having a flash memory module and formed on a surface of the second end of the circuit board and electrically connected with the circuit board; and
a central processing unit, formed on the other surface of the second end of the circuit board opposite to the flash memory and electrically connected with the flash memory and the circuit board; wherein the central processing unit has the central processing module and the adjustment module.

19. The micro display device for a micro display panel according to claim 18, wherein, the adjustment module further adjusts the gray-level value for each pixel based on the actual gray-level value offset of each pixel, wherein a bit depth of each pixel is 2 bits, 4 bits, or 8 bits.

20. The micro display device for a micro display panel according to claim 17, wherein, the micro display panel comprises inorganic micro LEDs; and, a standard gray coefficient is larger than the actual gray coefficient of a pixel.
